(19) United States
(12) Patent Application Publication
(10) Pub. No.: US 2005/0163297 A1
(43) Pub. Date: Jul. 28, 2005

(54) Device for and method of calculating charger for support service

(75) Inventors: Hideki Ise, Kawasaki (JP); Takashi Tanifuji, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/089,224

(22) Filed: Mar. 25, 2005

Related U.S. Application Data
(63) Continuation of application No. PCT/JP02/12371, filed on Nov. 27, 2002.

(51) Int. Cl. H04M 15/00

(52) U.S. Cl. 379/115.01; 379/114.01

(57) ABSTRACT

A support service charge calculating device comprises an accumulating means for accumulating in a storage means information on the use of the support service by customers during the support service providing period concerning an information processor provided to the customers on the condition that the customers pay a fixed charge, a calculating means for calculating the cost on the use during the providing period by using information on the use, and a determining means for determining the amount to be returned to the customers from the fixed charge when the relationship between the fixed charge and the use charge satisfies a predetermined condition.

This is a continuation of Application PCT/JP2002/012371, filed on Nov. 27, 2002.

### BACKGROUND OF THE INVENTION

1. Technical Field

The present invention relates to a device for and a method of calculating a charge for a support service about an information processing apparatus of a customer.

2. Background Arts

Over the recent years, there has been focused a support service, wherein a support company such as a provider performs maintenance, monitoring, an operation support, etc. via the Internet and a private line for an information processing device (a personal computer, a server device, etc.) purchased by a customer in order to actualize a stable operation of a system that gets large in scale and complicated in configuration.

In this support service, the following services are provided to the customer on condition that the customer pays a fixed amount of charge when establishing a contract. For example, a fault occurred in the customer's device is troubleshot (recovered from the fault) by dispatching a customer service engineer or by a remote operation of a support engineer, and so on. Further, if a failure occurs in the customer's device, a failed component is exchanged. Moreover, a customer's query about the system such as hardware, firmware, software, etc. by phone and by mail, is answered by a Q & A method.

In the case of the customer's enjoying being provided with the support service, a contract for providing the support service has hitherto been agreed upon between the customer and a support service provider, wherein the customer paid a fixed amount of charge when establishing the contract.

Therefore, the charge seems higher to the customer having the device with no system fault occurred or having no necessity of making a question about the system than the customer making the use of the support service at all times. Moreover, the support service adopted such a mode that once the customer pays the fixed charge, the questions are accepted any number of times during a contract term. Hence, there was a case in which some customers made such inquiries that the service providing side expects the customer side to solve problems that can probably be obviated by using, e.g., a help function or by referring to a manual. Accordingly, there are intermingled the questions from the customers, wherein some questions need advice and answers from the service providing side, while some questions do not need. The service providing side was unable to recognize a content of the question unless making an actual response, and therefore required ensuring a sufficient number of engineers capable of smoothly accepting all the questions from the customers in order to give the proper advice and answers for accepting and responding to the necessary questions.

Further, the support service took such a mode that the customer can select a repair method, and a price of a component necessary for the repair is paid from within the fixed charge. Therefore, if the support service target device would get into a failure, the customer often selected not a repair method of specifying the failed part and repairing or exchanging this part in a way that takes a considerable period of time but a repair method of exchanging all the components deemed to contain suspicious causes for the failure in order to shorten a period of device hang-up. In the latter method, even the components requiring none of the repair became the exchange target components, and therefore a repair cost for the components tended to increase.

Form the above-mentioned, the service providing side required allocating a good number of engineers for responding to a tremendous number of questions and narrowing down the component cost for the repair within expenditure on the service providing side. Accordingly, the service providing side had to set the fixed charge comparatively high in order to take cost-accounting for the support service. Thus, in the conventional support service, the charge was comparatively high to some of the customers who did not utilize. Further, the service company side (the provider side) was unable to increase the number of contractors with the support service for which the charge is set comparatively high, resulting in no rise in cost-volume-profit (revenue).

For others, ‘Information Processing Device, Information Processing Method, and Providing Medium’ in Japanese Patent Application Laid-Open Publication No. 2001-22843 and ‘Accounting System and Accounting Method Using Recording Medium’ in Japanese Patent Application Laid-Open Publication No. 2000-30099 are given as technologies related to the present invention.

### SUMMARY OF THE INVENTION

The present invention was devised in view of the problems given above. Namely, it is one object of the present invention to provide a charge calculation apparatus capable of increasing the number of contractors of a support service and promoting persons to enter into the contract.

It is another object of the present invention to provide a charge calculation apparatus capable of reducing a fixed charge for the support service.

The present invention adopted the following means in order to solve the problems described above. Namely, there present invention is a charge calculation apparatus related to a support service, comprising accumulating means accumulating a storage unit with information about a customer's service-utilized past record of utilizing a support service during a support service providing period regarding an information processing apparatus, which is provided on condition that a customer pays a fixed charge, calculating means calculating a charge for the service-utilized past record during the providing period as a service utilizing charge by use of information about the service-utilized past record, and determining means determining an amount of money to be returned to the customer from the fixed charge if a relation between the fixed charge and the service utilizing charge meets a predetermined condition.

It is preferable that the accumulating means may accumulate the storage unit with information about a content of each service provided to the customer as information about the service-utilized past record of the customer, the calculating means may calculate the service utilizing charge by adding up a pre-specified cost corresponding to each service content accumulated on the storage unit, and the determining means may determine an amount to be returned by setting, as an upper limit, an amount obtained by subtracting the fixed charge with the service utilizing charge.

Further, the present invention is a charge calculation apparatus related to a support service, comprising accumulating means accumulating a storage unit with information about a customer's service-utilized past record of utilizing a support service during a support service providing period regarding an information processing apparatus, which is provided on condition that a customer pays a fixed charge, calculating means calculating a charge for the service-utilized past record during the providing period as a service utilizing charge by use of information about the service-utilized past record, and determining means determining, when the customer makes a renewal of providing the support service, an amount of discount of the fixed charge for a renewal-related providing period on the basis of the service utilizing charge.

It is preferable that the accumulating means may accumulate the storage unit with information about a content of each service provided to the customer as information about the service-utilized past record of the customer, the calculating means may calculate the service utilizing charge by adding up a pre-specified cost corresponding to the content of each service accumulated on the storage unit, and the determining means may determines an amount of discount by setting, as an upper limit, an amount calculated based on a fixed condition from the fixed charge and the service utilizing charge.

The present invention may also be a method by which a computer executes any one of the processes described above. The present invention may further be a program for making the computer actualize any one of the functions described above.

According to the present invention, the system capable of managing the information about the service-utilized past record per customer is configured in the support service provided by customer's paying a fixed amount of charge when the customer signs up a contract, and the apparatus calculating the cost for the service-utilized past record by use of the information, and calculating an amount of money for cash-back from a relation with the fixed charge and also an amount of discount of the fixed charge when renewing the contract, is installed at a service center.

With this configuration, the center side can deal with, e.g., a question (query) from the customer as a service-utilized past record and can impose a charge for this query. Moreover, if the customer's apparatus gets into a fault, a price corresponding to an exchange component used for repairing can be summed up as the service-utilized past record per component. On the other hand, the customer side makes effort to become an object for the discount. For example, the customer does not query about a self-solvable content. Further, if the fault occurs in the apparatus, the customer selects a low-cost repairing method. As a result, on the center side (the service provider side), expenditure related to the support service is reduced, and the fixed charge for the support service can be decreased, whereby this can lead to increasing the number of contractors and promoting persons to enter into the contract.

### BRIEF DESCRIPTION OF THE DRAWINGS

FIG. 1 is an explanatory view of an outline of a support service system according to a first embodiment;

FIG. 2 is a block diagram showing one example of the system of a user terminal 1;

FIG. 3 is a view of a system configuration within the center;

FIG. 4 shows an example of a data structure of a device configuration/setting information table 60;

FIG. 5 shows an example of a data structure of a customer information table 61;

FIG. 6 shows an example of a data structure of an abnormality notification storage table 62;

FIG. 7 shows an example of a data structure of a query content storage table 63;

FIG. 8 shows an example of a data structure of a service past record table 64;

FIG. 9 shows an example of a data structure of a service charge table 65;

FIG. 10 shows an example of a data structure of a service contract table 66;

FIG. 11 shows an example of a processing flowchart for detecting abnormality in a user terminal 1 and notifying a center server 2 of this abnormality as event information;

FIG. 12 shows an example of a processing flowchart for detecting changes in the system configuration and in the setting information in the user terminal 1, and notifying the center server 2 of the changes as the event information;

FIG. 13 shows one example of a processing flowchart of functioning through a data linkage system 4;

FIG. 14 shows one example of a processing flowchart of functioning through a telephone linkage system 5;

FIG. 15 shows one example of a processing flowchart of functioning through a service support system 6;

FIG. 16 shows one example of a processing flow for managing, as a past record of the service, the service performed based on the processing flow shown in FIG. 15;

FIG. 17 shows one example of a processing flowchart of functioning through a charge totaling system 7;

FIG. 18 shows one example of a processing flowchart in which a utilized past record totaling program adds up the past records of the support services utilized by each user; and

FIG. 19 shows one example of a calculation process of converting the support service content on an amount-of-money basis, which is subjected to an add-up process by a utilized past record totaling program.

### DETAILED DESCRIPTION OF THE INVENTION

A preferred embodiment of the present invention will hereinafter be described with reference to the drawings.

<<Embodiment>>

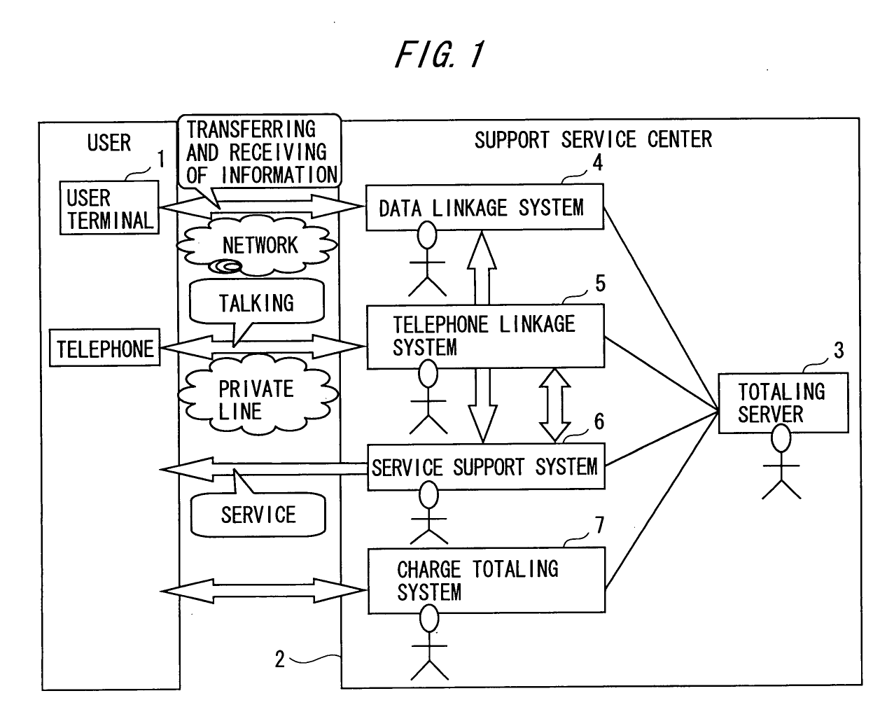

A support service system according to the embodiment of the present invention will hereinafter be explained with reference to the drawings in FIGS. 1 through 19.

<Outline of Support Service System>

FIG. 1 is an explanatory view of an outline of a support service system according to the present embodiment. This support service system calculates cash-back of a service charge and a discount quantity of the charge when making a continuing contract in accordance with a user-by-user past record of utilizing the service for a certain user as a service contractor (a service recipient) provided with a support service on condition of paying a fixed amount of money. This support service system includes a center server 2 installed at a support service center for providing the support service.

The center server 2 manages various categories of information occurred when providing services and adds up past records of utilizing the services. The center server 2 includes a data linkage system 4, a telephone linkage system 5, a service support system 6, a charge totaling system 7 and a totaling server 3. The totaling server 3 transfers and receives necessary pieces of information among these systems 4 through 7.

The data linkage system 4, which is connected via a network to a user terminal 1 as a support service target information processing device, provides the service by transferring and receiving the information between the user terminal 1 and the support service center, and manages the information about the user terminals 1 and the users (customers). The telephone linkage system 5 manages information occurred in the case of providing a dialog service between the user of the user terminal 1 utilizing the telephone and the support service center. The service support system 6 manages information related to a specific service provided to the user in linkage with the data linkage system 4 and the telephone linkage system 5. The charge totaling system 7 manages an amount of money (charge) for the service actually provided to the user on the basis of a support service contract.

Herein, the user, when provided with the support service, prepays the fixed amount of charge to a service provider in linkage with the respective systems 4 through 7. The totaling server 3 calculates a charge corresponding to a past record of the service utilized by the user when a user's contract term expires, and, if the charge corresponding to the past record of the service meets a predetermined condition in relation with an already-paid fixed charge, calculates an amount of money for the cash-back of part of the fixed charge to the user. Further, if the user establishes a continuing contract (renew the contract) for the support service, the totaling server 3, instead of calculating the amount of money that should be paid as the cash-back, calculates a discount quantity of the fixed charge for a next-term contract (a term of the contract to be renewed).

<Contents of Support Service>

The services provided as the support services are given as follows.
(1) Services Based on Data Network Linkage with User Terminal 1 and Center Server 2

The user terminal notifies the center server 2 of the following information (event information) as events.
\mathring{1} Notification of the customer information
\mathring{2} Notification of system configuration and version number within the user terminal 1
\mathring{3} Notification of fault information of the system within the user terminal 1
\mathring{4} Notification of alarm information of a system fault within the user terminal 1

The system in the user terminal 1 includes hardware, firmware and software.

On the side of the service center, the data linkage system 4 of the center server 2 receives and manages the event information notified on an event-basis, and enables the following services to be provided based on the event information. Examples of the providable services are given below.
(i) To download the firmware and the software managed by the data linkage system 4 of the center server 2 into the user terminal 1 on the basis of the event information notified in the events \mathring{2} through \mathring{4}, to revise the firmware and the software, and to apply a “patch”.
(ii) To effect troubleshooting on the user's side by revising the firmware and the software and applying the patch in such a way that a service man of the service center operates the user terminal 1 by a remote operation via the network.
(iii) To help the user operate the user terminal 1 by showing the event information notified in the events \mathring{2} through \mathring{4} on a Website that can be browsed by the user.
(2) Service in Telephone Network Linkage between User and Service Man of Center

A Q & A service (a question-and-answer service) using the telephone between the administrator (the user) of the user terminal 1, is provided. To be specific, the service man gives an answer to a question of the user on the phone. When the user gives a ring to the center, on the center side, the operator judges a type of content of the query from the user and connects the line to a support engineer in charge. The operator may utilize CTI (computer Telephony Integration) for this operation. Namely, the user himself or herself may manipulate a push button on the telephone in accordance with a computer-assisted guide on the center side and may thus connect to the object service man.
(3) Services Excluding (1) and (2)

The following services are provided to the user from the center side.
(i) To provide hardware components for exchange
(ii) To provide a storage medium stored with the (revised and patch-applied) firmware and software.
(iii) To provide the updated information on the hardware, the firmware and the software and the most advanced technologies in a written form.
(iv) To troubleshoot the hardware, the firmware and the software by dispatching a customer service engineer to a destination of the user.

<User Terminal>

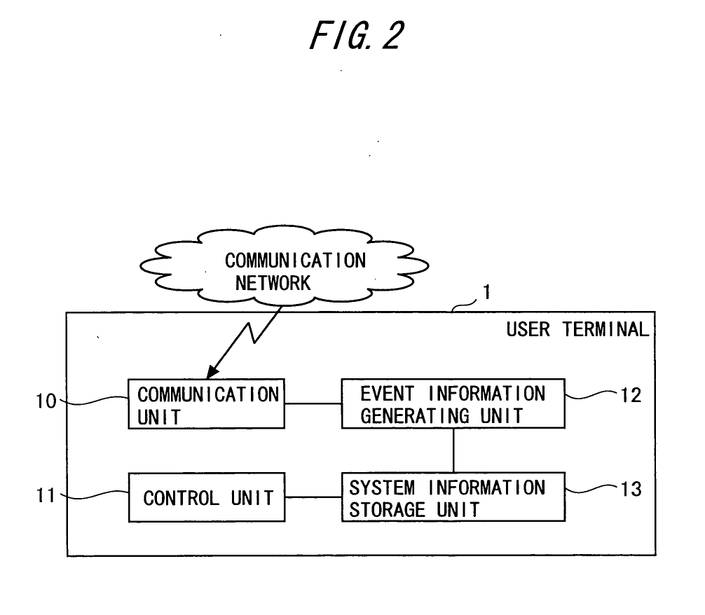

FIG. 2 is a block diagram showing one example of the system of the user terminal 1. The user terminal 1 is a computer such as a personal computer (PC), a workstation (WS), a server machine, etc. and includes, though not illustrated, a processor such as a CPU, etc., a main storage device, an auxiliary storage device, a communication control device and an output device. The auxiliary storage device is installed with a dedicated program for executing the event for the center server 2. The dedicated program is provided from the service provider by establishing, e.g., a support service contract with the user, and is preinstalled before a start of a service providing period (a contract term).

As shown in FIG. 2, the user terminal 1 functions, based on execution of the dedicated program, as a device including a communication unit 10, a control unit 11, an event information generating unit 12 and a system information storage unit 13. The control unit 11 obtains and stores customer information, a system configuration, version number information on the system information storage unit 13. Further, the control unit 11 always monitors a log of processes executed on the user terminal 1, detects a fault and an alarm in the system, and stores these pieces of information on the system information storage unit 13. The event information generating unit 12 generates the event information corresponding to the event on the basis of the information stored on the system information storage unit 13. The communication unit 10 sends the event information to the center server 2. A variety of existing communication protocols (such as HTTP (HyperText Transfer Protocol), FTP (File Transfer Protocol), SMTP (Simple Mail Transfer Protocol), etc.) can be utilized as transmitting means of the event information. The system information storage unit 13 is stored with a record of the log monitored by the control unit 11 and pieces of information on the intra-system configuration and setting detected by the control unit 11. The stored information is read when generating the event information which the center is notified of.

Note that the user terminal 1 periodically executes the events \mathring{1} and \mathring{2} given above, and, when detecting fault and the fault alarm by monitoring the log, executes the events \mathring{3} and \mathring{4} described above.

<Center>

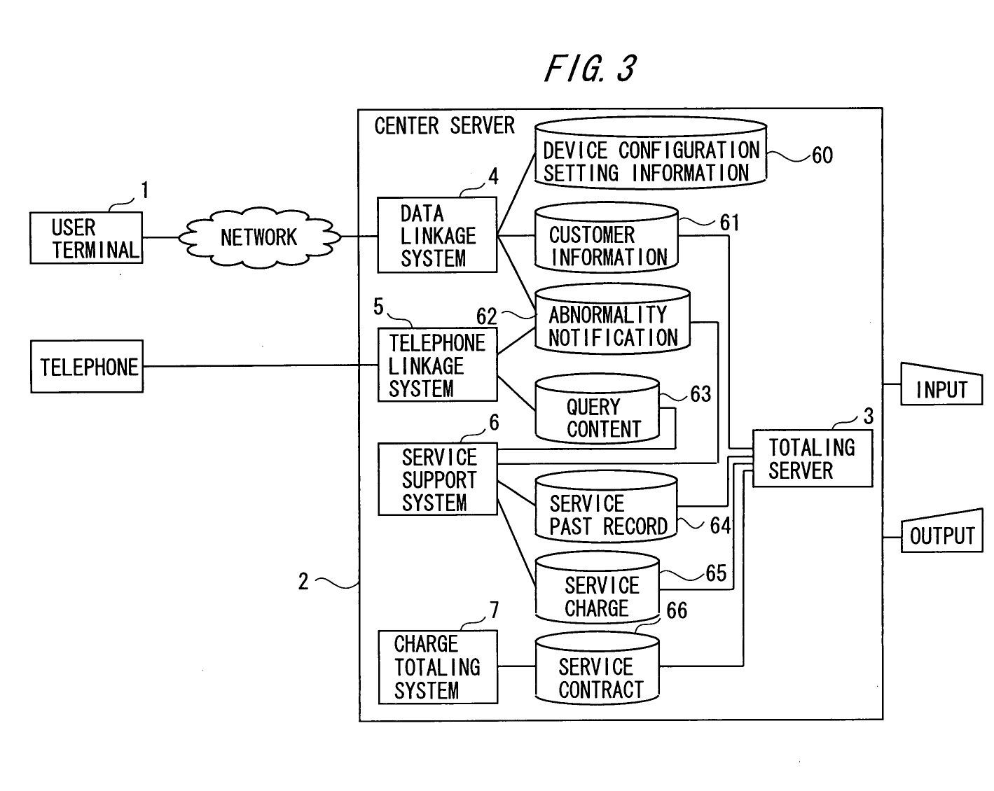

FIG. 3 is a diagram showing the system configuration of an interior of the center. FIG. 3 shows an example of actualizing the totaling server 3 and the respective systems 4 through 7 illustrated in FIG. 1 as the center server 2 on one single server machine. The intra-center system can be also, however, configured by one or more computers for implementing the functions of the totaling server 3 and of the systems 4 through 7. The intra-center system may be, for instance, configured such that each of the computers actualizes each of the functions 3 through 7, and five pieces of computers are set in linkage with each other, and may also be configured by a computer for actualizing the systems 4 through 7 and by the computer for actualizing the totaling server 3. The unillustrated CPU executes an application programs for implementing these functions, thereby actualizing the totaling server 3 and the systems 4 through 7.

The data linkage system 4 shown in FIG. 3 receives the event information which the user terminal 1 notifies of.

The data linkage system 4 is linked to a device configuration/setting information table 60 for storing the system configuration and the version number information in the user terminal, a customer information table 61 for storing customer information of the user and an abnormality notification storage table 62 for storing an abnormality message indicating a fault and an alarm notified as the event information. The data linkage system 4 stores the respective tables 60, 61, 62 with the event information received from the user terminal 1 according to the type of the event information, thus managing the event information. Moreover, the data linkage system 4 can control functions of providing an environment for the user terminal to download the firmware and the software, providing an environment for the support engineer to remotely operating the user terminal 1, and providing a Web site browsed by the user of the user terminal 1, and so on.

The telephone linkage system 5 linked to the tables 62, 63, when the center side accepts the query from each user on the phone and if a content of this query is a notification about abnormality, stores this notification as an abnormality message on the abnormality notification storage table 62, thus managing the abnormality notification. Further, if the content is other than the abnormality notification, the telephone linkage system 5 stores this content on the query content storage table 63, thus managing the query content.

The service support system 6 stores a service past record table 64 linked to the system 6 itself with information about a content of the support service responding to each abnormality message registered in the abnormality notification storage table 62 and with the query content registered in the query content storage table 63. Moreover, the service support system 6 being linked to a service charge table 65 predefines a service charge corresponding to each service content registered in the service past record table 64.

The charge totaling system 7 stores a service contract table 66 linked to the system 7 itself with information about a content of the support service contract agreed upon between the user and the service provider.

The totaling server 3 is linked to the customer information table 61, the service past record table 64, the service charge table 65 and the service contract table 66. The totaling server 3 adds up charges for past records of the services utilized by the customer during the contract term, and calculates an amount of money for cash-back corresponding to the past records of the utilized services or an amount of money of a discount of the contract charge in a next term by comparing with a fixed service charge prepaid by the user.

Note that the aforementioned service support system 6 corresponds to an accumulating unit according to the present invention. Further, the service past record table 64 corresponds to a storage unit according to the present invention. Moreover, the totaling server 3 corresponds to a calculating means and a determining means according to the present invention.

<Data Structure>

Next, data structures of the respective tables 60 through 66 will be explained.

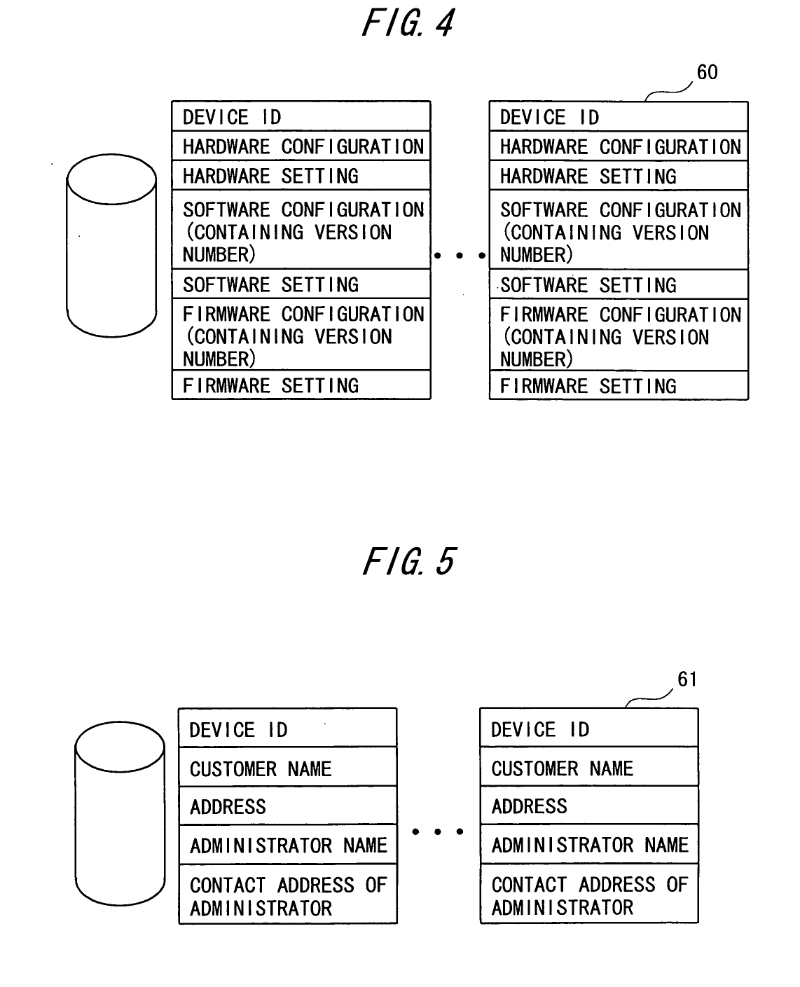

FIG. 4 shows an example of the data structure of the device configuration/setting information table 60. In the device configuration/setting information table 60, pieces of information related to the support service target device are registered on a device-by-device basis. Each column in the table shown in FIG. 4 corresponds to one record in the device configuration/setting information table 60, wherein the information about one single user terminal 1 serving as the service target device is retained. The record in the device configuration/setting information table 60 has fields showing a device ID, hardware configuration information, hardware setting information, software configuration information, software setting information, firmware configuration information and firmware setting information, respectively.

The device ID is a unique number for identifying the terminal as the support service target device. Further, the hardware configuration information, the hardware setting information, the software configuration information, the software setting information, the firmware configuration information and firmware setting information, are pieces of information about the system within the user terminal 1.

These pieces of information are notified upon an event executed periodically on the user terminal 1 and are registered in the table 60. If the notification content is updated or changed, the record corresponding thereto is updated and registered. Accordingly, this table 60 retains and manages the latest system state in each user terminal 1.

FIG. 5 shows an example of the data structure of the customer information table 61. Registered in the customer information table 61 are pieces of information on the user who owns the user terminal 1 as the support service target device. Each column in the table shown in FIG. 5 corresponds to one record in the customer information table 61, wherein pieces of information on an individual user are retained. The record in the customer information table 61 has fields showing a device ID, a customer name, an address, an administrator name and a contact address of the administrator, respectively.

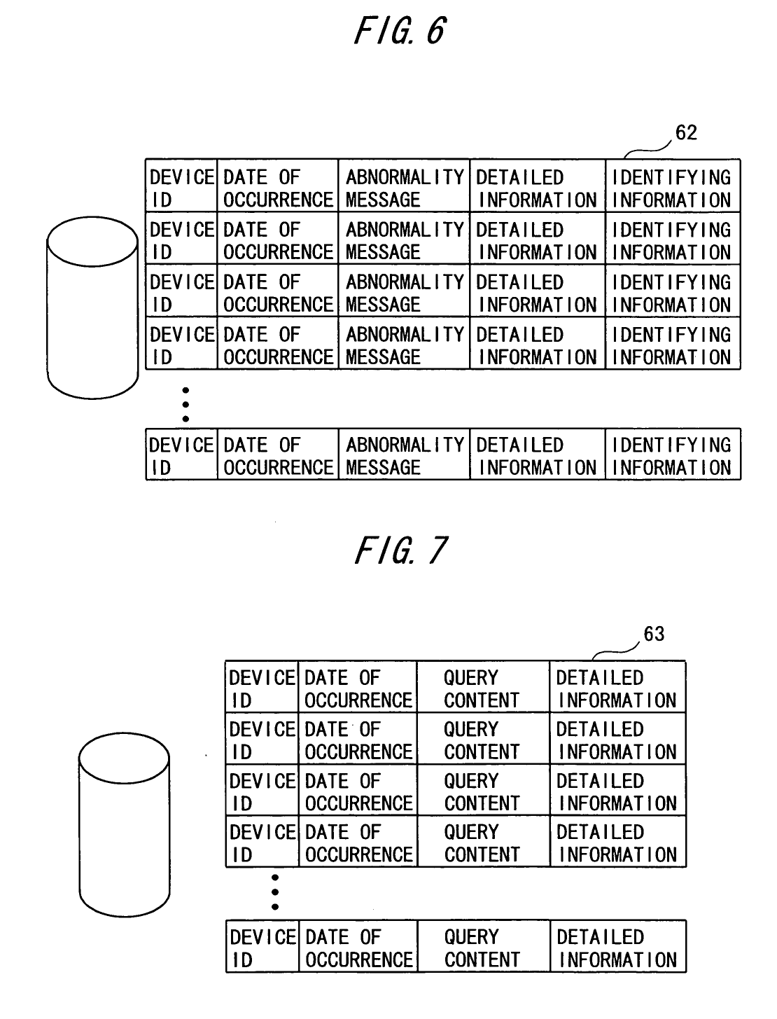

FIG. 6 shows an example of the data structure of the abnormality notification storage table 62. In the case of judging from monitoring the log a necessity of notifying of an abnormality message, if a fault occurs in the user terminal 1, indicating the occurrence of the fault or inducing the system to get suspicious of the occurrence of the fault, a content of the event information to be notified is registered in the abnormality notification storage table 62. Alternatively, a content to notify of the abnormality in response to a query from the user is registered in this table 62. Each row in the table shown in FIG. 6 corresponds to one record in the abnormality notification storage table 62, wherein pieces of information about the single terminal as the target device are retained. The record in the abnormality notification storage table 62 has fields showing a device ID, an occurrence date, an abnormality message, detailed information and identifying information, respectively. These pieces of information are registered based on the event information of which each user terminal 1 notifies via the network or the content of the query given from the user. An identifier for distinguishing between the notification via the network and the notification via the telephone, is registered in the identifying information.

FIG. 7 shows an example of the data structure of the query content storage table 63. When each individual user utilizing the user terminal 1 gives a query to the center on the phone, the query content other than the content to notify of the abnormality is registered in the query content storage table 63. Each row in the table shown in FIG. 7 corresponds to one record in the query content storage table 63, wherein pieces of information about one single terminal as the target device are retained. The record in the query content storage table 63 has fields showing, a device ID, an occurrence date, a query content and detailed information, respectively.

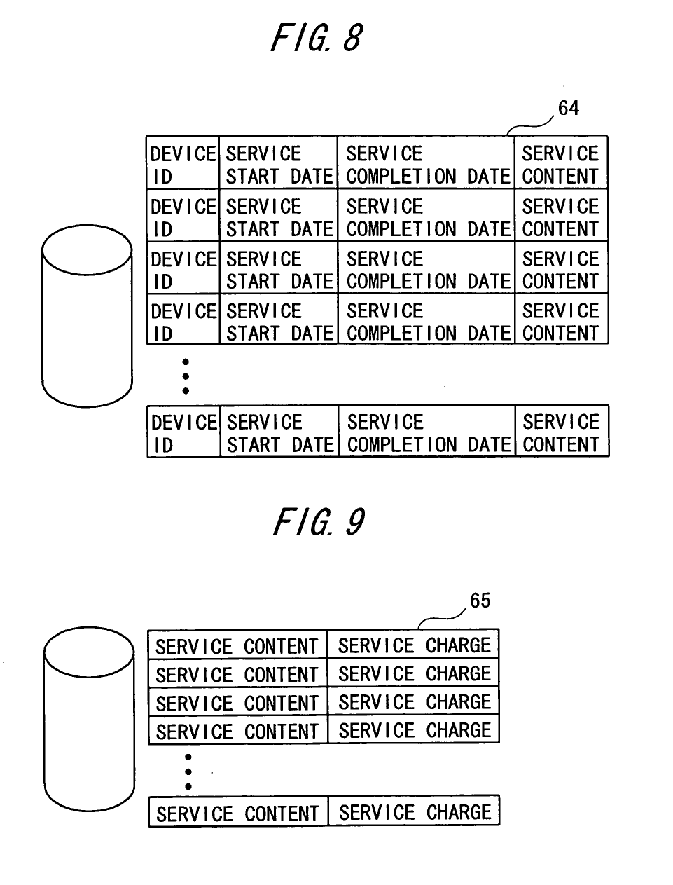

FIG. 8 shows an example of the data structure of the service past record table 64. The service past record table 64 is registered with a past record of the support service for every user terminal 1. Each row in the table shown in FIG. 8 corresponds to one record in the service past record table 64, wherein pieces of information about one single terminal as the target device are retained. Th record in the service past record table 64 has fields showing a device ID, a service start date, a service completion date and a service content, respectively.

FIG. 9 shows an example of the data structure of the service charge table 65. The service charge table 65 is registered with a service charge associated with every service content. Each row in the table shown in FIG. 9 corresponds to one record in the service charge table 65, wherein a piece of charge information for one service content is retained. The record in the service charge table 65 has fields showing the service content and the service charge, respectively. These pieces of information are read at a point of time when adding up the past records of utilizing the support services.

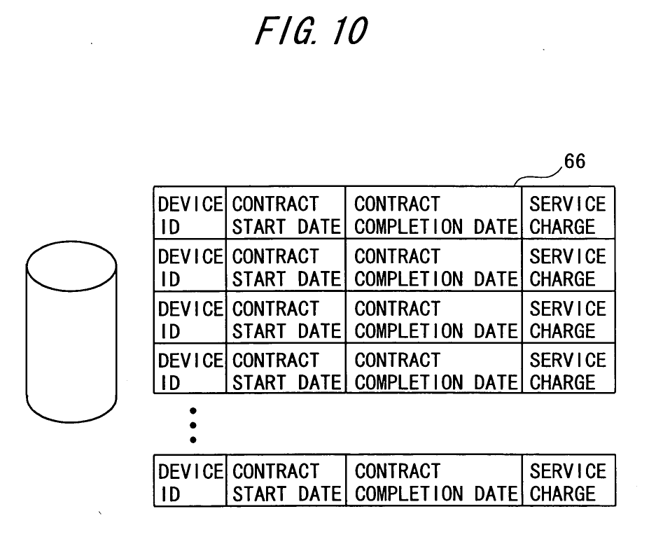

FIG. 10 shows an example of the data structure of the service contract table 66. The service contract table 66 is registered with a content of the support service contract agreed upon between the user and the service provider. Each row in the table shown in FIG. 10 corresponds to one record in the service contract table 66, wherein there is retained a contract content regarding one single terminal about which the service contract is established. The record in the service contract table 66 has fields showing a device ID, a contract start date, a contract completion date and a service charge, respectively. These pieces of information are registered at a point of time when the user signs up the support service contract. The service charge connoted herein is a fixed charge just when establishing the contract. This service charge is read just when adding up the past records of utilizing the support services.

<Processes on User Terminal>

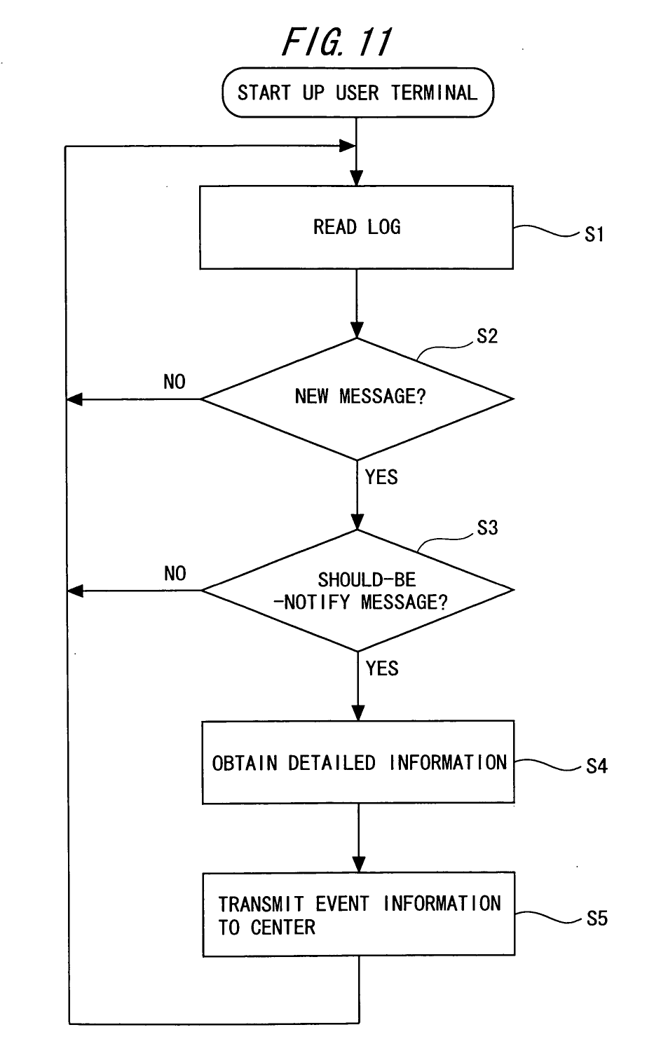

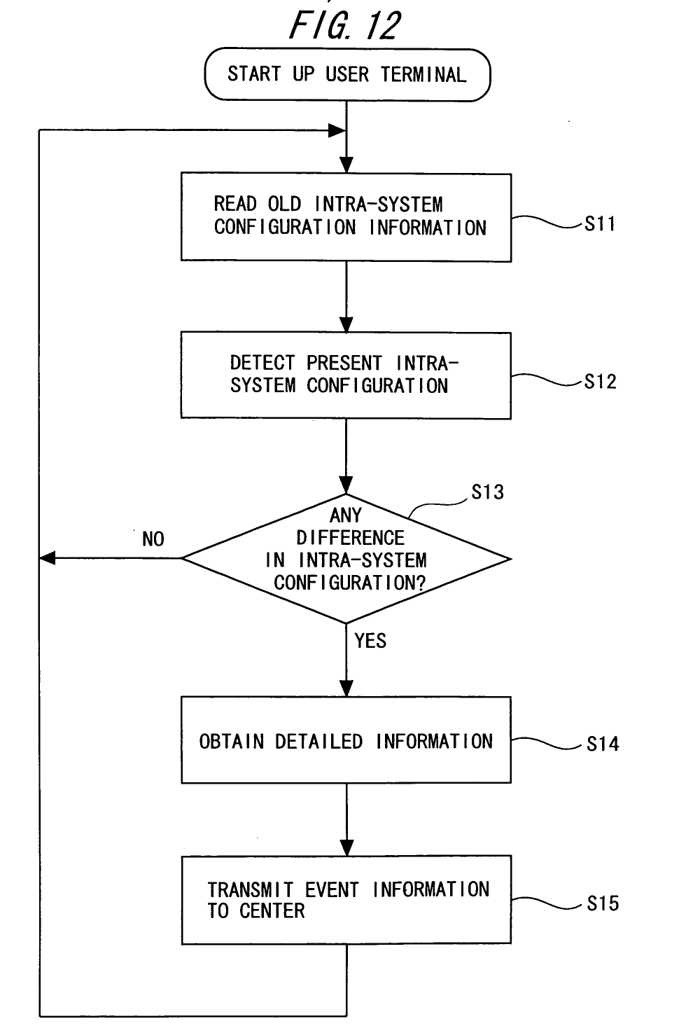

Next, processes on the user terminal 1 will be explained with reference to FIGS. 11 and 12. The following processes shown in FIGS. 11 and 12 are actualized by a dedicated program executed by the unillustrated CPU of the user terminal 1. Moreover, the processes shown in FIGS. 11 and 12 are always executed during a period from the startup to the stop of the user terminal 1.

FIG. 11 shows an example of a processing flowchart for detecting the abnormality in the user terminal 1 and notifying the center server 2 of this abnormality as the event information. This process runs, wherein the event information generating unit 12 is a main unit for this process. To begin with, the log is periodically read from the system information storage unit 13 (S1). Then, the readout log is analyzed, and it is judged whether there is a new message or not (S2). When judging that a new abnormality message exists, it is judged whether or not this message is a message which the center should be notified of (S3). Namely, it is judged whether or not there is the message (abnormality message) indicating the abnormality or the suspicion of the abnormality detected in the user terminal 1. In the case of judging that the message is the should-notify massage, the detailed information showing a content of the abnormality message is acquired (S4). The acquired detailed information is transferred together with the abnormality message to the communication unit 10, and is sent as the event information to the center server 2 via the network from the communication unit 10 (S5). The thus-sent information is stored in the abnormality notification storage table 62 in the data linkage system 4.

FIG. 12 shows an example of a processing flowchart for detecting changes in the system configuration and in the setting information in the user terminal 1, and notifying the center server 2 of the changes as the event information. This process runs, wherein the event information generating unit 12 is the main unit for this process. To start with, the old information about the intra-system configuration is periodically read from the system information storage unit 13 (S11). Next, the present intra-system configuration is detected by within the control unit 11 (S12). The execution of this detection may, for example, within the user terminal 1, involve detecting a configuration as to whether a new hardware interface exists or not, etc., on the basis of the log in the system. Then, it is compared whether there is a difference between the old configuration information read from the system information storage unit 13 and the thus-detected present configuration information (S13). If there is the difference, the detailed information to be notified as the event information is acquired (S14). The detailed information acquired is transferred to the communication unit 10 and sent as the event information to the center server 2 via the network from the communication unit 10 (S15). The thus-sent information is stored in the device configuration/setting information table 60 in the data linkage system 4.

<Processes in Center Server>

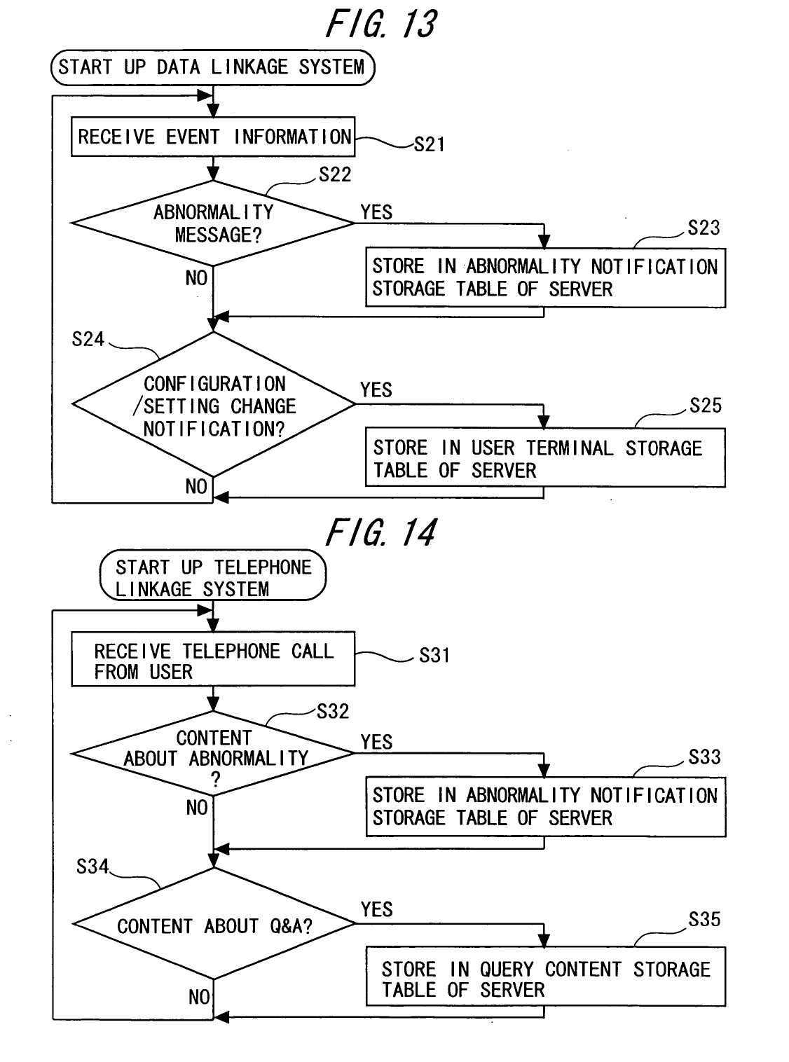

Next, processes in the center will be explained with reference to FIGS. 13 through 17.

FIG. 13 shows one example of a processing flowchart of functioning through the data linkage system 4. The event information to be notified via the network is processed by a data linkage program shown in FIG. 13 in the data linkage system 4.

At first, the service center receives the event information to be notified via the network from the user terminal 1 (S21). It is judged whether the received event information is an abnormality message about the user terminal 1 or not (S22). In the case of the abnormality message, this abnormality message is stored in the abnormality notification storage table 62 (S23). If not the abnormality message, it is judged whether or not the event information is a notification for informing of changes in the system configuration and in the setting within the user terminal 1 (S24). In the case of the notification for informing of the changes in the system configuration and in the setting, this notification is stored in the device configuration/setting information table 60 (S25). With this contrivance, on the side of the support service center, the event information received via the network from the user terminal 1 can be stored according to the purpose, and the optimum support service can be provided to every user terminal 1.

FIG. 14 shows one example of a processing flowchart of functioning through the telephone linkage system 5. The information notified via the phone is processed by the telephone linkage program shown in FIG. 14 in the telephone linkage system.

To start with, on the side of the support service center 2, the operator receives a telephone call from the user (S31). Next, the query content is judged. At first, it is judged whether or not a content of conversing with the user is information related to the abnormality in the user terminal 1 (S32). In the case of the content to notify of the abnormality, this notification is stored in the abnormality notification storage table 62 (S33). If not the content to notify of the abnormality, it is judged whether the content is related to “Q & A” about the user terminal 1 (S34). In the case of “Q & A” about the user terminal 1, this query content is stored in the query content storage table 63 (S35). With this contrivance, the center can manage the information received via the phone from the user terminal 1 according to the purpose, and can provide the optimum support service to each user terminal 1.

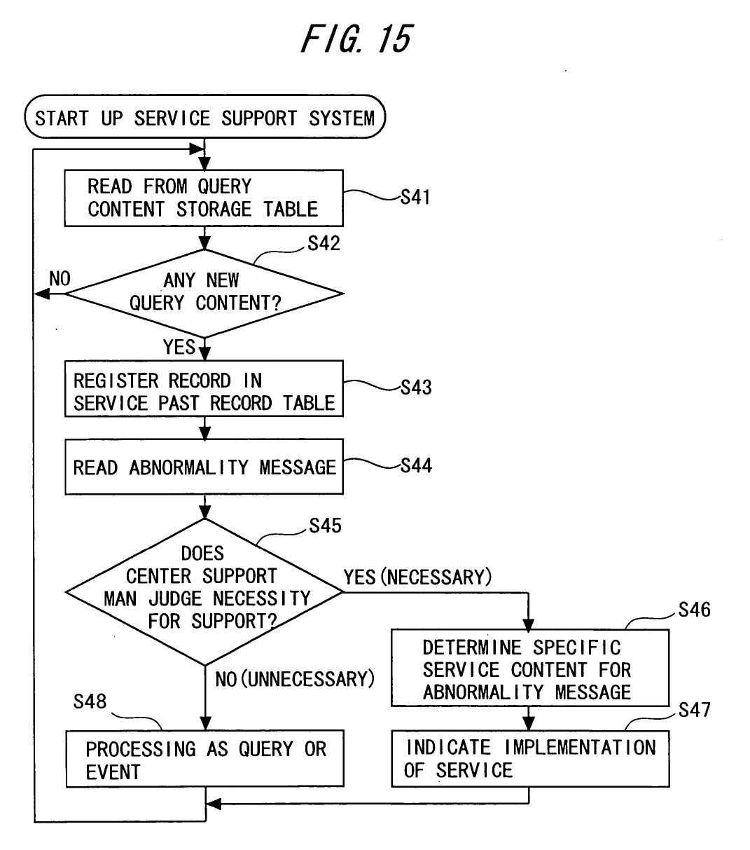

FIG. 15 shows one example of a processing flowchart of functioning through the service support system 6. Based on the information from the user, which has been stored by the functions of the data linkage system 4 and of the telephone linkage system 5, a specific support service is provided to each user through the service support program shown in FIG. 15 in the service support system 6.

To begin with, the content of the query content storage table 63 is read out (S41) Then, it is judged whether or not a new query content exists in the query content storage table 63 (S42). If the new query content exists, this query content is registered in the service past record table 64 (S43). For example, the occurrence date registered in the query content storage table 63 may be registered as a service start date and a service completion date in the service past record table 64. Further, the query content and the detailed information in the query content storage table 63 may be registered as a service content in the service past record table 64. Namely, the “Q & A” conducted is registered in the record-format as a past record of utilizing the service. Next, the abnormality message is read from the abnormality notification storage table 62 (S44). The center support engineer judges about the readout abnormality message whether the support is required or not (S45). When judging that the support is required, the center support engineer determines a specific service content with respect to the abnormality message (S46). At this time, a support service start month/day and a content of the service to be carried out are registered in the service past record table 64. Then, the support engineer available on the start month/day and suited to the service content is given an instruction to carry out the support service (S47). In the case of judging that any support is not required, this information is so processed as to be registered as the query or the event in the service past record table 64 (S48). With this contrivance, the center considers, as the past records of utilizing the service, the event notification and the query received from the user terminal 1 or the user, and can deal with them as accounting target information.

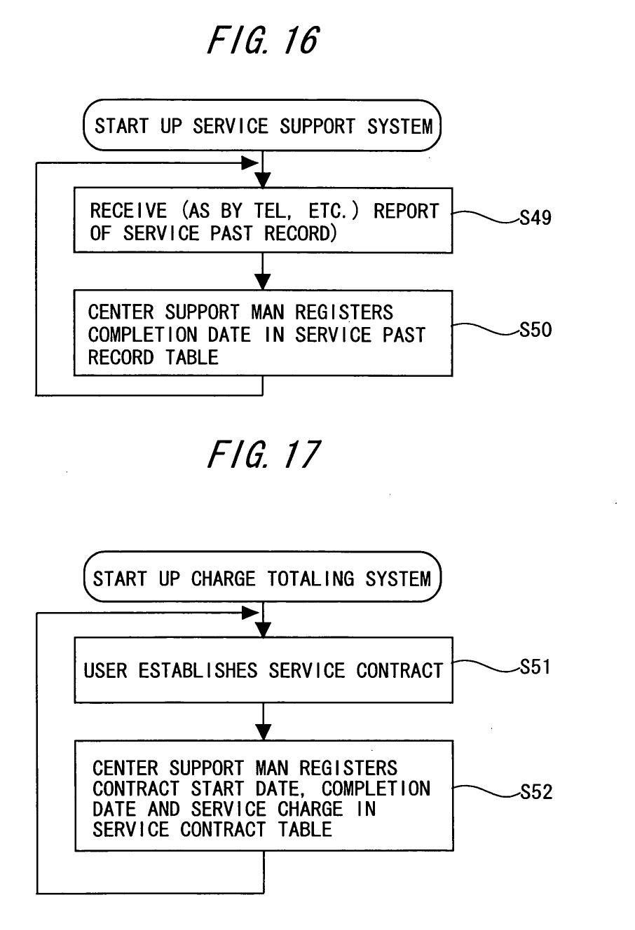

FIG. 16 shows one example of a processing flow for managing, as a past record of the service, the service performed based on the processing flow shown in FIG. 15.

A report about the completion of the service is received from the support engineer who performed the support service (S49). The center support engineer receiving the report registers the completion month/day of the support service in the service past record table 64 (S50). With this registration, the center can manage the conducted support service as the service past record.

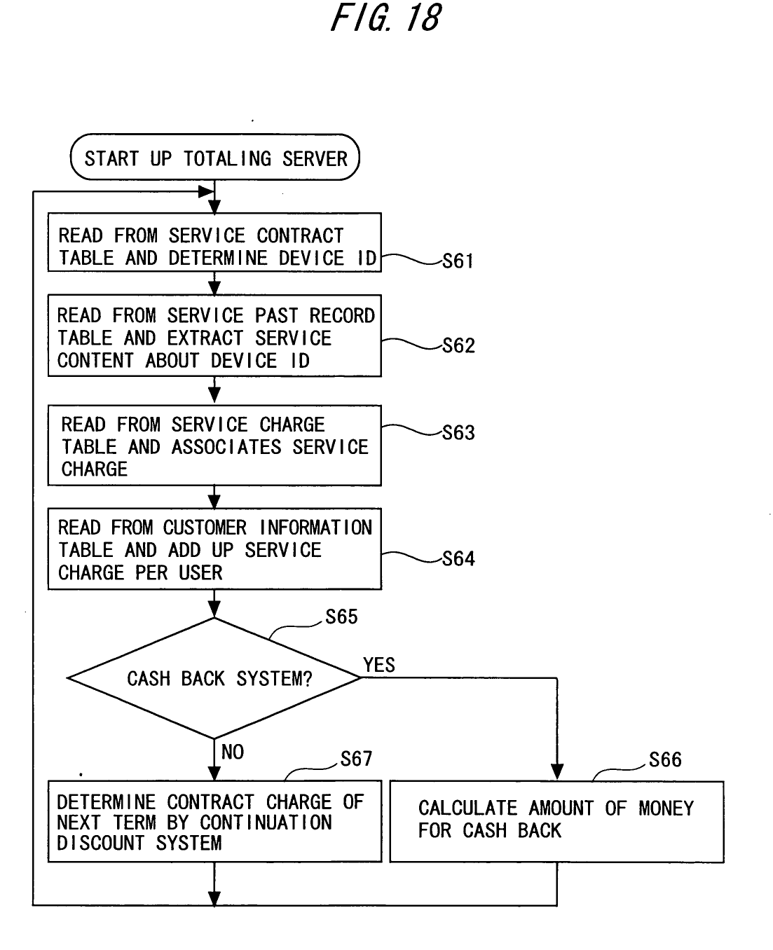

FIG. 17 shows one example of a processing flowchart of functioning through the charge totaling system 7. When the user signs up a contract for the support service, this contract content is managed by a charge totaling program shown in FIG. 17 in the charge totaling system 7.

To begin with, the user signs up the contract for the support service (S51). This contract basically represents a new contract and may also be a continuing contract in a next term. Next, upon a receipt of the support service contract, the center support engineer registers a contract start date, a contract completion date and a service charge as a content of the contract in the service contract table 66 (S52). At this time, the contract content, in the case of the continuing contract in the next term, is updated and thus registered. With this registration, the center can manage the contract content for the support service on the user-by-user basis.

<Example of Adding up Support Services>

FIG. 18 shows one example of a processing flowchart in which a utilized past record totaling program adds up the past records of the support services utilized by each user. This program, in the totaling server 3, functions on the last day of the support contract term and converts the past record of utilizing the support service performed for each device on an amount-of-money basis, and offers a discount corresponding to the user's past record of the support service.

At first, the service contract table 66 is read out, and the device ID about which the totaling process is executed, is determined (S61). Next, the service past record table 64 is read out, and the service of the utilized service is extracted for every device ID (S62). Namely, the service content of the service performed for every device is extracted as the past record of the service. Next, the service charge table 65 is read out, and a preset service charge is associated with the service content extracted in S62 (S63). At this time, there is executed a process of converting the past record of the service into an amount of money in a way that associates the service charger registered in the service charge table 65 with each service content. Namely, the past record of the utilized service is converted into a numeric value and shown as the amount of money for utilizing. Subsequently, the customer information table 61 is read out, and service charges of every customer who owns each device are totaled (S64). Herein, it is judged whether a discount is estimated based on a cash-back method or not (S65). Namely, it is judged whether or not the customer renews the contract for the support service. In the case of the discount based on the cash-back method, a specific amount of money for the cash-back is determined (S66). This amount of money is calculated based on a preset calculation formula. If not discounted based on the cash-back method, i.e., if the customer renews the contract for the support service, a contract charge in the next contract term is determined by a continuing contract discount method (S67). Specifically, an amount of money, into which the next term contract charge is discounted from a normally-set contract charge, is calculated. This amount of money is calculated based on a preset calculation formula.

<Example of Calculation Process of Support Service>

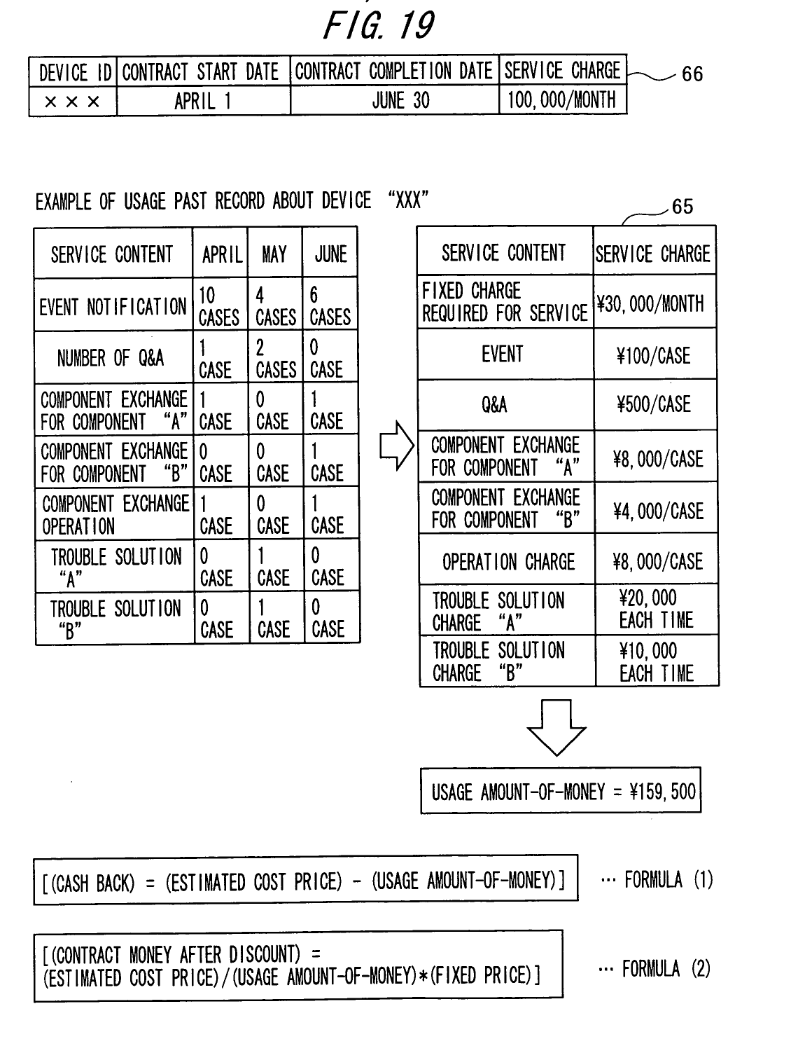

FIG. 19 shows one example of a calculation process of converting the support service content on the amount-of-money basis, which is subjected to the add-up process by the utilized past record totaling program. The example of the utilized past record in FIG. 19 specifically shows the service contents added up per month as the utilized past record of the support services for the user terminal 1 serving as the add-up process target device.

At first, the service contract table 66 is read out, and the device ID, about which the add-up process is executed, is determined from the contract term. Next, all pieces of information associated with this device ID are read from the service past record table 64. The information read out herein is added up according to the number of cases per month as the utilized past record of the support service. This utilized past record represents, e.g., the event notification from the user terminal 1, the number of cases of using the “Q & A” on the phone, the number of cases of exchanging a component when the user terminal gets into a fault, the number of cases of troubleshooting conducted by sending the customer service engineer for performing the support, and so on. As for the exchange of the component, prices of the respective components are managed as the number of cases of exchanging the components, and the part exchanging operations are managed as the number of cases of the part exchanging operations. Accordingly, if the customer exchanges the component by himself or herself, it follows that an operation cost is not added. Further, the troubleshooting is ranked into A and B. This ranking is setting corresponding to a level of the support service. This level may be determined from a period of time expended for the support and may also be determined by referring to a manual created for judging a content of the support level.

With this contrivance, the center can sum up the charge per component with respect to the service utilized past record. Further, the service utilized past records can be summed up according to the time expended for the support and to the level classification.

Next, the service charge table 65 is read out. In the service charge table 65, for instance, as shown in FIG. 19, a fixed charge required for the service per month and a service charge for one case of each service content are associated with each other. Then, the added-up utilized past record is converted on the amount-of-money basis, and an amount of money for utilizing the support service is calculated based on the content of the readout service charge table 65. The example given in FIG. 19 shows that the amount of money for utilizing the support service comes to 159,500 yen.

Next, a specific discount is calculated from the contract content read from the service contract table 66. This support service is, as shown in FIG. 19, provided for a 3-month contract term ranging from April to June with a support service contact charge that is cost at 100,000 yen per month, and is therefore performed totally at 300,000 yen for three months.

The amount of money in the case of giving the cash-back is calculated by, e.g., the formula (1). To be specific, an estimated cost price is calculated in a way that takes account of a 30% profit of the support service charge defined as revenue, the support service past record is subtracted from this estimated cost price, and a remaining amount of money is set as the cash-back money. At this time, if the calculated amount money is minus, this is not treated as an object for the cash-back. Hereat, in the example in FIG. 19, the estimated cost price is 210,000 yen, and 15,9500 yen as the amount of money for utilizing is subtracted from 210,000 yen, resulting in 50,500 yen for the cash-back money.

Further, a discount of the amount of money for the next-term contract is given to the user who signs up the continuing contract in the next term. The discount quantity for the contract in the next term is calculated by, e.g. the formula (2). To be specific, an estimated cost price for three months is calculated taking account of the 30% profit of the support service charge defined as the revenue, and is divided by the amount of money for utilizing, and a value as a result of this division is multiplied by a fixed support service charge per month, whereby a value as a result of this multiplication becomes an amount of money for the next-term contract. At this time, in the example in FIG. 18, the estimated cost price is 210,000 yen, and 210,000 yen is divided by 159,000 yen as the amount of money for utilizing, and the value as the result of this division is multiplied by 100,000 as the support service fixed charge, whereby the amount of money for the contract in the next term becomes 76,000 yen per month.

Thus, the center can calculate the cash-back money and the discount money of the contract charge in the next term according to the service utilized past record of every user.

<Effects>

According to the present invention, the device having the function of managing all the information necessary for the support service is provided at the center on the side of the company that provides the support service, the service utilized by the customer is converted on the amount-of-money basis according to the preset table information, thereby associating the service with accounting and enabling the cash-back and the discount of the contract charge for the continuing contract.

Consequently, the customers make effort so as not to receive the service such as the question about, e.g., the intra-device system to the greatest possible degree in order to become the object for the discount. Then, the company for providing the service can reduce the number of service operations as caused by the questions from the customers. As a result, the company can decrease the fixed charge for the support service owing to the reduction in the number of such operations, and this can lead to improvement of a contract establishing rate and to an increase in cost-volume-profit (revenue).

<Modified Example>

In the embodiment discussed above, the discount money for the user who signs up the continuing contract is calculated based on the amount of money for the contract and the amount of money for utilizing the service. The amount of money for the next-term contract may also be discounted according to the user's contract term by fluctuating a discount rate corresponding to a renewal period of the continuing contract for every user. This discount money is calculated by predefining a constant corresponding to the contract term. For instance, the discount money may be calculated in a way that multiplies the amount of money for the next-term contract that is calculated by the formula (2) given above by the constant corresponding to the contract term. An incentive can be thereby given to a long-term contract of every user.

<<Industrial Applicability>>

The present invention can be applied to a service industry, a communication industry, etc. that perform the supporting such as maintenance, monitoring, an operating support, etc. via the Internet and the private lines in a variety of information device systems.

<<Others>>

The disclosures of international application PCT/JP2002/012371, filed on Nov. 27, 2002 including the specification, drawings and abstract are incorporated herein by reference.

1. A charge calculation apparatus related to a support service, comprising:
accumulating means accumulating a storage unit with information about a customer's service-utilized past record of utilizing a support service during a support service providing period regarding an information processing apparatus, which is provided on condition that a customer pays a fixed charge;
calculating means calculating a charge for the service-utilized past record during the providing period as a service utilizing charge by use of information about the service-utilized past record; and
determining means determining an amount of money to be returned to the customer from the fixed charge if a relation between the fixed charge and the service utilizing charge meets a predetermined condition.

2. A charge calculation apparatus according to claim 1, wherein said accumulating means accumulates said storage unit with information about a content of each service provided to the customer as information about the service-utilized past record of the customer,
said calculating means calculates the service utilizing charge by adding up a pre-specified cost corresponding to the content of each service accumulated on said storage unit, and
said determining means determines an amount to be returned by setting, as an upper limit, an amount obtained by subtracting the fixed charge with the service utilizing charge.

3. A charge calculation apparatus related to a support service, comprising:
accumulating means accumulating a storage unit with information about a customer's service-utilized past record of utilizing a support service during a support service providing period regarding an information processing apparatus, which is provided on condition that a customer pays a fixed charge;
calculating means calculating a charge for the service-utilized past record during the providing period as a service utilizing charge by use of information about the service-utilized past record; and
determining means determining, when the customer makes a renewal of providing the support service, an amount of discount of the fixed charge for a renewal-related providing period on the basis of the service utilizing charge.

4. A charge calculation apparatus according to claim 3, wherein said accumulating means accumulates said storage unit with information about a content of each service provided to the customer as information about the service-utilized past record of the customer,
said calculating means calculates the service utilizing charge by adding up a pre-specified cost corresponding to the content of each service accumulated on said storage unit, and
said determining means determines an amount of discount by setting, as an upper limit, an amount calculated based on a predetermined condition from the fixed charge and the service utilizing charge.

5. A charge calculation method related to a support service, comprising:
an accumulating step making a computer accumulate information about a customer's service-utilized past record of utilizing a support service during a support service providing period regarding an information processing apparatus in a storage unit, which is provided on condition that a customer pays a fixed charge;
a calculating step making said computer calculate a charge for the service-utilized past record during the providing period as a service utilizing charge by use of information about the service-utilized past record; and
a determining step making said computer determine an amount of money to be returned to the customer from the fixed charge if a relation between the fixed charge and the service utilizing charge meets a predetermined condition.

6. A charge calculation method according to claim 5, wherein said computer accumulates information about a content of each service provided to the customer in said storage unit as information about the service-utilized past record of the customer,
said computer calculates, in said calculating step, the service utilizing charge by adding up a pre-specified cost corresponding to the content of each service accumulated in said storage unit, and
said computer determines, in said determining step, an amount to be returned by setting, as an upper limit, an amount obtained by subtracting the fixed charge with the service utilizing charge.

7. A charge calculation method related to a support service, comprising:
an accumulating step making a computer accumulate information about a customer's service-utilized past record of utilizing a support service during a support service providing period regarding an information processing apparatus in a storage unit, which is provided on condition that a customer pays a fixed charge;
a calculating step calculating a charge for the service-utilized past record during the providing period as a service utilizing charge by use of information about the service-utilized past record; and
a determining step determining, when the customer makes a renewal of providing the support service, an amount of discount of the fixed charge for a renewal-related providing period on the basis of the service utilizing charge.

8. A charge calculation method according to claim 7, wherein said computer accumulates information about a content of each service provided to the customer in said storage unit as information about the service-utilized past record of the customer,
said computer calculates, in said calculating step, the service utilizing charge by adding up a pre-specified cost corresponding to each service content accumulated in said storage unit, and
said computer determines, in said determining step, an amount of discount by setting, as an upper limit, an amount calculated based on a predetermined condition from the fixed charge and the service utilizing charge.

9. A charge calculation program related to a support service, for making a computer execute:
an accumulating step accumulating information about a customer's service-utilized past record of utilizing a support service during a support service providing period regarding an information processing apparatus in a storage unit, which is provided on condition that a customer pays a fixed charge;
a calculating step calculating a charge for the service-utilized past record during the providing period as a service utilizing charge by use of information about the service-utilized past record; and
a determining step determining an amount of money to be returned to the customer from the fixed charge if a relation between the fixed charge and the service utilizing charge meets a predetermined condition.

10. A charge calculation program according to claim 9, wherein said computer is made to accumulate information about a content of each service provided to the customer in said storage unit as information about the service-utilized past record of the customer,
said computer is made to calculate, in said calculating step, the service utilizing charge by adding up a pre-specified cost corresponding to each service content accumulated in said storage unit, and
said computer is made to determine, in said determining step, an amount to be returned by setting, as an upper limit, an amount obtained by subtracting the fixed charge with the service utilizing charge.

11. A charge calculation program related to a support service, for making a computer execute:
an accumulating step accumulating information about a customer's service-utilized past record of utilizing a support service during a support service providing period regarding an information processing apparatus in a storage unit, which is provided on condition that a customer pays a fixed charge;
a calculating step calculating a charge for the service-utilized past record during the providing period as a service utilizing charge by use of information about the service-utilized past record; and
a determining step determining, when the customer makes a renewal of providing the support service, an amount of discount of the fixed charge for a renewal-related providing period on the basis of the service utilizing charge.

12. A charge calculation program according to claim 11, wherein said computer is made to accumulate information about a content of each service provided to the customer in said storage unit as information about the service-utilized past record of the customer,
said computer is made to calculate, in said calculating step, the service utilizing charge by adding up a pre-specified cost corresponding to the content of each service accumulated in said storage unit, and
said computer is made to determine, in said determining step, an amount of discount by setting, as an upper limit, an amount calculated based on a predetermined condition from the predetermined charge and the service utilizing charge.
